(19) United States
(12) Patent Application Publication
(10) Pub. No.: US 2008/0139005 A1
(43) Pub. Date: Jun. 12, 2008

(54) ELECTRIC CONNECTOR ASSEMBLY

(75) Inventors: GUO-FU GUO, Shenzhen (CN); CHANG-CHUN LIU, Shenzhen (CN); XIAO-LIN GAN, Shenzhen (CN); YU-KUANG HO, Taipei Hsien (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 11/828,353

(22) Filed: Jul. 26, 2007

(30) Foreign Application Priority Data
Dec. 6, 2006 (CN) 200610201224.4

(51) Int. Cl. H01R 11/30

(52) U.S. Cl. 439/39

(57) ABSTRACT

An electric connector assembly includes a plug includes a plurality of pins, at least one fastening member detachably mounted on the plug, and a socket comprising a plurality of slots. Each fastening member includes a magnetic shaft. At least one locking sleeve defining a hole with a magnetic wall is arranged beside the slots. The pins of the plug are inserted into the corresponding slots of the socket. Magnetic attraction between the fastening member and the locking sleeve firmly retains the shaft in the locking hole to hold the plug in the socket.

### BACKGROUND OF THE INVENTION

1. Field of the Invention

The present invention relates to electric connector assemblies incorporating megnetic connecting structure

2. Description of related art

With the development of electronics, many interfaces, such as video graphics array (VGA), digital visual interface (DVI), line parallel terminal (LPT) and so on, have been employed on electronic devices for connecting to other electronic devices. A conventional method for connecting female and male connectors is to utilize screws to reinforce the connection between the female connector and plugs of the male connector.

Referring to FIG. 3, a conventional DVI male connector 10 for connecting to an electronic device such as a host computer is illustrated. A conventional female connector 20 is to be connected to a peripheral device such as a DVI display device. The male connector 10 includes a main body 12 having two mounting portions 16 formed at two opposite sides thereof respectively, and a housing 1 4 at an end of the main body 1 2 for housing a plurality of pins (not shown) therein. A through hole 162 is defined in each mounting portion 16 of the male connector 10. The main body 12 is made of a non-conductive material. The pins positioned in the housing 14 are electrically connected to the electronic device. The female connector 20 includes a receptacle 22, and two locking sleeve 24 positioned at two opposite sides of the receptacle 22 respectively. The receptacle 22 includes a plurality of slots 222 electrically connected to the peripheral device. A screw hole 242 is defined in each locking sleeve 24.

In assembly, the pins of the male connector 10 are inserted into the corresponding slots 222 of the female connector 20. Two screws 50 extend through the through holes 1 62 of the male connector 10, and screw into the screw holes 242 of the female connector 20. However, it is unduly cumbersome and time-consuming to screw each screw 50.

What is needed is a connector assembly which does not need screwing method and can be easily fastened.

### SUMMARY OF THE INVENTION

An exemplary electric connector assembly includes a plug includes a plurality of pins, at least one fastening member detachably mounted on the plug, and a socket comprising a plurality of slots. Each fastening member includes a magnetic shaft. At least one locking sleeve defining a hole with a magnetic wall is arranged beside the slots. The pins of the plug are inserted into the corresponding slots of the socket. Magnetic attraction between the fastening member and the locking sleeve firmly retains the shaft in the locking hole to hold the plug in the socket.

Other advantages and novel features of the present invention will become more apparent from the following detailed description of a preferred embodiment when taken in conjunction with the accompanying drawings, in which:

### BRIEF DESCRIPTION OF THE DRAWINGS

FIG. 1 is an exploded, isometric view of an electric connector assembly according to an embodiment of the present invention;

FIG. 2 is an assembled view of FIG. 1; and

FIG. 3 is an exploded, isometric view of a conventional connector assembly.

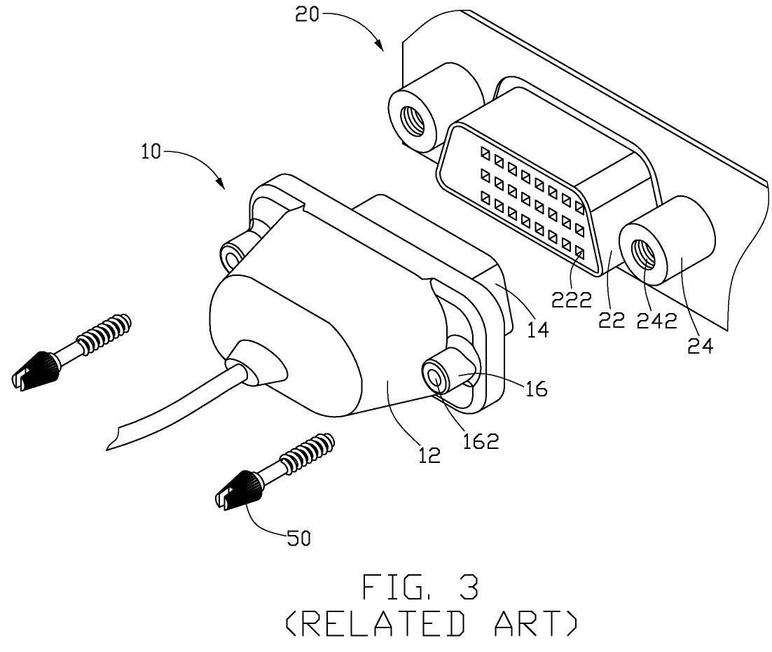

### DETAILED DESCRIPTION OF THE INVENTION

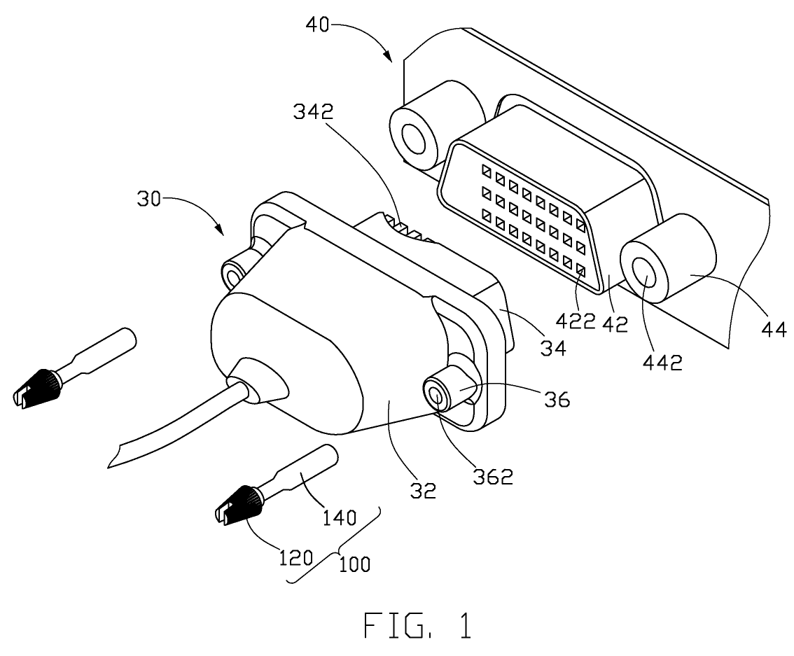

Referring to FIG. 1, an electric connector assembly according to an embodiment of the present invention includes a male connector 30, such as a plug configured for connecting to an electronic device such as a host computer, and a female connector 40, such as a socket configured for connecting to a peripheral device such as a DVI display device.

The male connector 30 includes a main body 32 having two mounting portions 36 formed at two opposite sides thereof respectively, and a housing 34 at a front end of the main body 32 for housing a plurality of pins 342 therein. A through hole 362 is defined in each mounting portion 36 of the male connector 30. The main body 32 is made of a non-conductive material. The pins 342 positioned in the housing 34 are electrically connected to the electronic device via a cable at a rear end of the main body 32.

The female connector 40 includes a receptacle 42, and two locking sleeves 44 positioned at two opposite sides of the receptacle 42 respectively. The receptacle 42 includes a plurality of slots 422 electrically connected to the peripheral device. A locking hole 442 with a magnetic wall is defined in each locking sleeve 44.

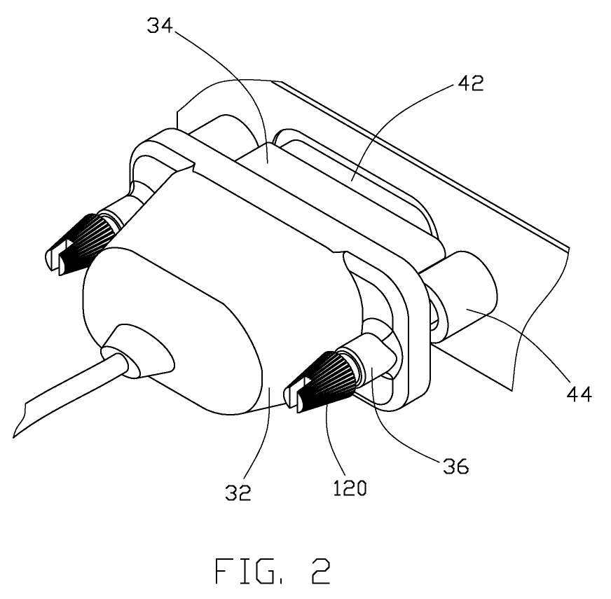

Referring also to FIG. 2, to make the electrical connection between the electronic device and the peripheral device, the pins 342 of the male connector 30 are inserted into the corresponding slots 422 of the female connector 40. To maintain and reinforce the electrical connection, two fastening members 100 are inserted through the through holes 362 of the mounting portions 16 of the male connector 30 respectively. Each fastening member 100 includes a cone-shaped operation portion 120, and a magnetic shaft 140 extending from an end of the operation portion 120.

Attractive forces between the fastening members 100 and the respective locking sleeves 44 attract the shafts 1 40 into the respective locking holes 442 of the locking sleeves 44, and biase the operation portions 120 against the mounting portions 36 respectively helping to hold the male connector 30 to the female connector 40. The length of each shaft 140 can be adjusted according to the depth of the locking hole 442 of each locking sleeve 44. In the embodiment, all of the shafts 140 and the locking sleeves 44 are magnets, either permanent or electromagnetic, or alternatively either the shaft 140 or the locking sleeve 44 is a magnet, either permanent or electromagnetic, while the other is made of complementary element such as a ferromagnetic material.

The male connector 30 and the female connector 40 of the electric connector assembly are fastened by the magnetic attraction between the fastening members 100 and the locking sleeves 44, which is convenient and time-saving. Besides devices with the DVI interface, other devices with VGA interfaces or LPT interfaces can use this magnetic connecter assembly as well.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electric connector assembly, comprising:
a male connector comprising a main body having at least one mounting portion positioned on a side thereof, and a housing fixed to one end of the main body for positioning therein a plurality of pins configured to electrically connect to an electronic device, a through hole defined in the at least one mounting portion;
a female connector comprising a receptacle having a plurality of slots electrically connected to a peripheral device, and at least one locking sleeve positioned on a side thereof, a hole defined in the at least one locking sleeve, the slots configured for receiving the corresponding pins of the male connector; and
at least one fastening member comprising an operation portion, and a shaft extending from an end of the operation portion, the shaft inserted through the through hole of the at least one mounting portion, wherein the at least one fastening member and the at least one locking sleeve has magnetic attraction formed therebetween to firmly retain the shaft of the at least one fastening member in the locking hole of the at least one locking sleeve respectively.

2. The electric connector assembly as described in claim 1, wherein both the at least one fastening member and the at least one locking sleeve are made of permanent material or electromagnetic material, arranged to attract magnetically to one another.

3. The electric connector assembly as described in claim 1, wherein one of the at least one fastening member and the at least one locking sleeve is made of permanent material or electromagnetic material, while the other is made of a ferromagnetic material.

4. The electric connector assembly as described in claim 1, wherein the main body is made of a non-conductive material.

5. The electric connector assembly as described in claim 1, wherein the operation portion of the at least one fastening member biases against the at least one mounting portion toward the at least one locking sleeve when the shaft is attached in the locking hole of the at least one locking sleeve.

6. An electric connector assembly, comprising:
a plug comprising a plurality of pins, and at least one fastening member detachably mounted on the plug, the at least one fastening member comprising a shaft being magnetic;
a socket comprising a plurality of slots configured to receive the pins respectively, and at least one locking sleeve defining a hole with a magnetic wall arranged besides the slots, magnetic attraction between the at least one fastening member and the at least one locking sleeve substantially retaining the shaft of the at least one fastening member adsorbed into the locking hole of the at least one locking sleeve respectively to hold the plug to the socket.

7. The electric connector assembly as described in claim 6, wherein both the at least one fastening member and the at least one locking sleeve are made of permanent material or electromagnetic material arranged to attract magnetically to one another.

8. The electric connector assembly as described in claim 6, wherein the main body is made of a non-conductive material.

9. An electric connector assembly comprising:
a female connector electrically connected to an electronic device, the female connector comprising a receptacle defining a plurality of slots and at least one locking sleeve positioned beside the receptacle, a hole being defined in the at least one locking sleeve;
a male connector configured to electrically connect to another electronic device, the male connector comprising a housing having a plurality of pins configured to be attached to the receptacle with the pins inserted into the slots respectively, and at least one mounting portion arranged beside the housing, a through hole defined in the at least one mounting portion; and
at least one fastening member comprising an operation portion and a shaft extending from the operation portion, the shaft of the at least one fastening member inserted through the through hole of the at least one mounting portion to be received in the hole of the at least one locking sleeve, wherein one of the shaft of the at least one fastening member and the at least one locking sleeve is made of magnetic material such that a magnetic attraction is formed therebetween to firmly retain the shaft in the locking hole.

10. The electric connector assembly as described in claim 9, wherein both the at least one fastening member and the at least one locking sleeve are made of permanent material or electromagnetic material.

11. The electric connector assembly as described in claim 9, wherein the other one of the at least one fastening member and the at least one locking sleeve is made of ferromagnetic material.
